(19) United States
(12) Patent Application Publication
(10) Pub. No.: US 2010/0300398 A1
(43) Pub. Date: Dec. 2, 2010

(54) SELECTABLE DECORATIVE COVER SYSTEM

(76) Inventor: Lawrence Edward Weymouth, JR., Windham, NH (US)

Correspondence Address: SEYFARTH SHAW LLP, WORLD TRADE CENTER EAST, TWO SEAPORT LANE, SUITE 300, BOSTON, MA, 02210-2028, US

(21) Appl. No.: 12/476,353

(22) Filed: Jun. 2, 2009

(51) Int. Cl. F02B 77/00; B23P 11/00

(52) U.S. Cl. 123/198 E; 29/428

(57) ABSTRACT

A cover assembly is comprised of a first cover and a second cover configured for juxtaposed attachment to the first cover. The second cover can be an assembly of two pieces or more wherein at least one of the pieces is attached to the first cover in a manner so that it can rotate in relation to the first cover.

### FIELD OF THE INVENTION

The present invention relates to exposed covers for internal aspects of a mechanical system, such as a cover on an engine of a motorcycle.

### BACKGROUND OF THE INVENTION

Engine covers are known, such as for example the Timing Chain Cover For A Motorcycle Engine as described in U.S. Pat. No. D525,268 issued to Stahel et al. While the ornamental aspects of the cover may be appreciated, it should be further appreciated that in order to change ornamentality the entire cover needs to be changed and replaced by a cover with a different ornamental design. This can result in exposure of critical engine parts and/or the introduction of dirt, debris, etc to critical mechanical aspects of the vehicle.

Other covers are known, such as a “Derby cover” as shipped on most motorcycles, which is just a plain cover. The Derby cover is basically a dust cover that fits on the left side of the motorcycle engine/mechanics and covers the mechanical aspects of the clutch. It is typically a larger cover with 4-6 screws holding it in place when the screws are secured to the clutch housing. In some instances the Derby cover has no screws. Instead there may be a screw-cap in the center with a large closed slot in the center. Derby covers may be plain, such as illustrated in FIG. 1. Custom covers can be purchased that have unique designs, such as illustrated in U.S. Pat. No. D411,972 issued to Long. But, known custom covers are one piece without the ability to change designs without buying a whole new cover. To change the decorative nature of the cover the entire cover needs to be replaced. Taking off the cover may undesirably expose critical mechanical aspects of the motorcycle, and may in turn have negative implications for any warrantee.

It is known to change ornamental aspects on a motorcycle, such as illustrated in Patent Application Publication US2005/050254920 in which a motorcycle bolt head cover is disclosed that includes a decorative part that may be removable/replaceable. While wheel nut and bolt covers are well known in the art, they are typically configured to have limited applicability for use, and the particular configurations are not suited for larger-scale applications.

Given differing and ever-changing tastes in style, and the genuine interest in motorcycle and automotive enthusiasts generally to “customize” their machines to express taste and personality, heretofore known covers are not suitable to the task of large-scale and frequent change in ornamentality.

### SUMMARY OF THE INVENTION

The present invention provides a cover system that is readily adaptable to large-scale style-change applications.

In one embodiment of the invention, a cover is provided, such as a Derby cover for a motorcycle. The Derby cover according to the invention is comprised of a first cover attachable to a portion of a vehicle. At least one, or a set of fasteners is configured for attaching the first cover to the vehicle portion. A second cover plate is configured for juxtaposed attachment to the first cover and/or the portion of the vehicle, with at least one or a set of fasteners configured for making such attachment.

In another embodiment of the invention, a second cover is comprised of a background and a medallion (one or the other or both may be decorative). A bearing configuration is provided and disposed between the first cover and second cover pieces. In this embodiment, the medallion is fixed and the background insert spins.

In still another embodiment of the invention, a second cover is comprised of a background and a medallion (one or the other or both may be decorative). A bearing configuration is provided and disposed between the first cover and second cover pieces. In this embodiment, the medallion is configured to spin and the background insert is fixed.

The present invention provides several variations for customizing and personalizing portions of a vehicle, such as a motorcycle, ATV, scooter, or the like.

### BRIEF DESCRIPTION OF THE DRAWINGS

FIG. 1 is a plan view of a typical derby cover as known in the prior art;

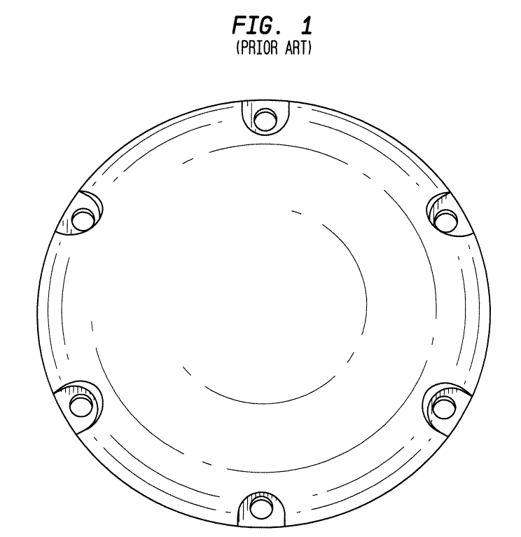

FIG. 2 is a plan view of a selectable decorative cover according to the invention;

FIG. 3 is an exploded view of a first embodiment of a selectable decorative cover according to the invention;

FIG. 4 is an exploded view of a second embodiment of a selectable decorative cover according to the invention; and

FIG. 5 is an exploded view of a third embodiment of a selectable decorative cover according to the invention.

### DETAILED DESCRIPTION OF THE INVENTION

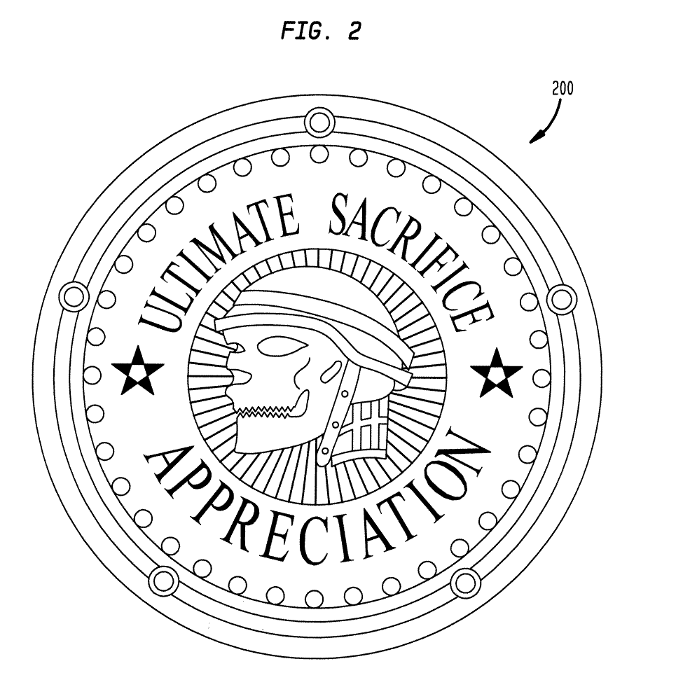

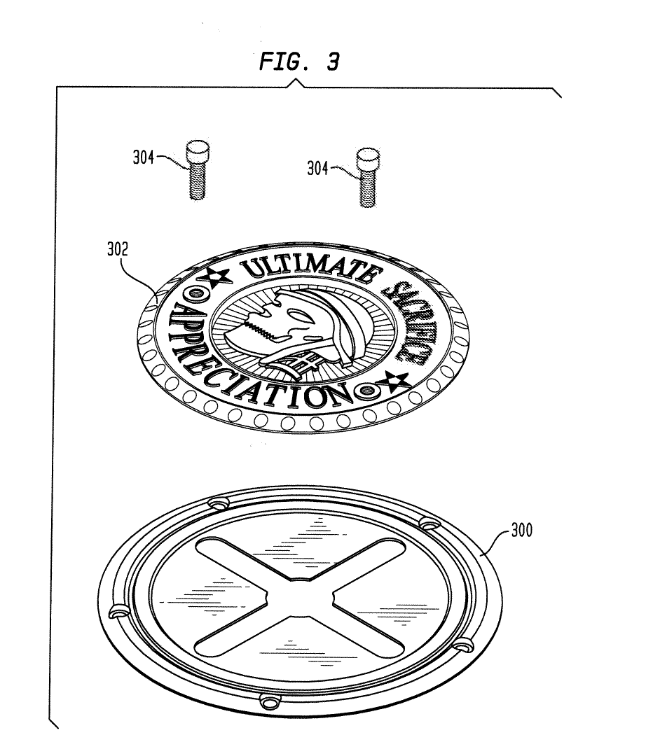

A fully assembled embodiment of a selectable decorative cover system according to the invention is illustrated in FIG. 2. This illustrative embodiment is a Derby cover 200. The cover, illustrated further in the exploded view of FIG. 3, is configured with a first cover or plate 300 that is mechanically attached to the motorcycle clutch housing (not shown) as is generally known in the art. A second cover 302, which may be configured from one or more decorative pieces in relation to one another is mechanically fastened to the first cover 300. The second cover 302, which is comprised of customizing ornamental aspects, such as decorative painting, sculpting, metal-work or the like, may be mechanically fastened to the first cover and/or the clutch housing. The second cover 302 and its ornamentality may be removed and replaced with different ornamentality. In this simple two piece embodiment, bolts 304 hold the second 302, ornamental cover to the base cover 300.

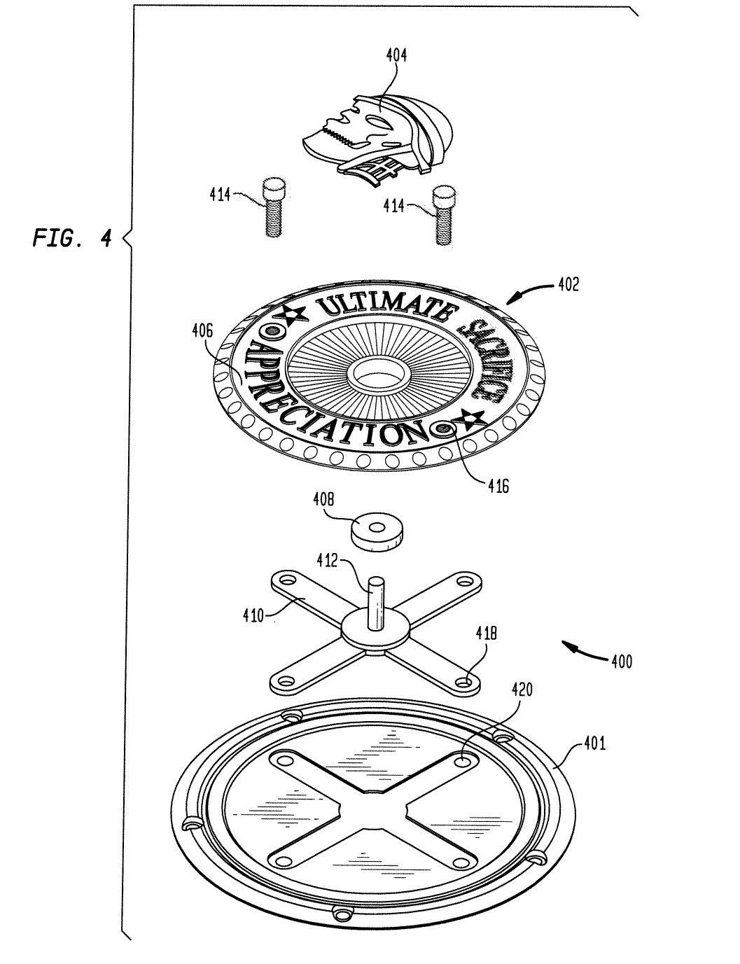

Referring now to FIG. 4, an embodiment of a decorative cover system 400 is illustrated having a first cover 401 wherein a second cover 402 is comprised of multiple pieces, in this case two pieces referred to herein as a medallion 404 and a background insert 406. In this illustrative embodiment the medallion 404 is fixed and the background insert 406 is configured to spin. To facilitate this configuration, a bearing configuration is comprised of a bearing assembly 408 and a bearing bracket 410. The bearing configuration is disposed between the first cover and second cover pieces. Specifically, in this illustrative embodiment, the bearing assembly 408 is press fit onto a post 412 of the bearing bracket 410. The post 412 is long enough to protrude through the bearing assembly 408, the background insert 406, and into the medallion 404. The background insert 406 is press fit onto the bearing assembly 408 outer surface. The medallion 404 is press fit onto the protruding post 412. A plurality of bolts 414 completely pass through full clearance holes 416 in the background insert 406, through countersunk clearance holes 418 in the bearing bracket 410 and thread into corresponding holes 420 the first or base cover 401. Thus the post and medallion are fixed and the background insert that is friction fit to the bearing assembly spins with the outer bearing surface.

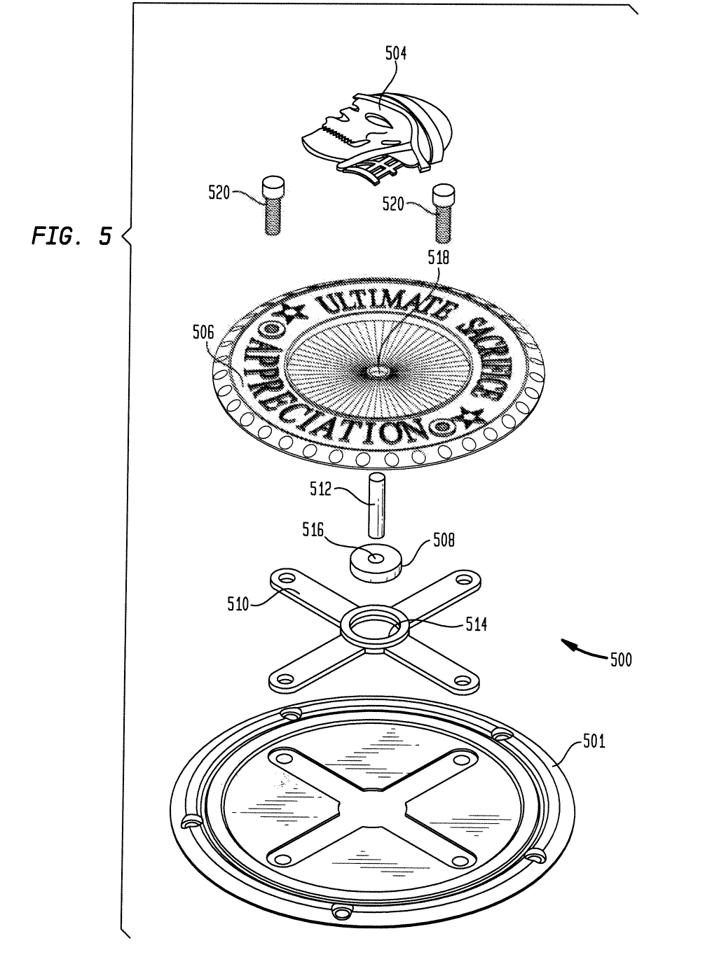

Referring now to FIG. 5, an embodiment of a decorative cover system 500 is illustrated having a first cover 501 wherein the second cover 502 is comprised of multiple pieces, in this case two pieces are also referred to herein as a medallion 504 and a background insert 506. In this illustrative embodiment the medallion 504 is configured to spin and the background insert 506 is fixed. To facilitate this configuration, a bearing configuration is comprised of a bearing assembly 508, a bearing bracket 510 and an independent bearing post 512. In this configuration the bearing assembly 508 is press fit into a center hub 514 of the bearing bracket 510. The independent post 512 is press fit into a center hole 516 of the bearing assembly 508. The background insert 506 is placed over bearing bracket 510 in a manner so the post 512 protrudes through a center clearance hole 518 of the background insert 506. The medallion 504 is press fit onto the bearing post 512. Bolts 520 are positioned and installed to go through the background insert 506 and bearing bracket 510 holding them both firmly to the base/first cover 501. In this configuration the medallion 504 spins freely on bearing post 512 and the background insert 506 is fixed.

In the foregoing embodiments of the invention, the threaded holes in the first/base cover are not threaded completely through. Thus, the base cover need not be removed from engine to change the background insert or second cover to an alternative design.

After market motorcycle Derby covers, or other covers according to the invention, may be manufactured with several bolt patterns to fit, but not limited to, early and late model “Harley Davidson” and “S & S” motors. The unique design features will allow the end user to change the look and style without removing the cover from the bike by way of the interchangeable medallion and/or background assembly. These assemblies may be of a vast variety in style, color and design and simply attach to (by way of small bolts) and detach from the base cover.

Although various aspects of the embodiments described herein are described as being press fit or friction fit, it should be appreciated by those skilled in the art that other means of fastening the various pieces may be implemented, such as by use of mechanical fasteners, adhesives such as glue or epoxy, mechanical interfaces or the like. Similarly, although “bolts” are described for fastening and generally 2 bolts are illustrated it should be appreciated by those skilled in the art that other means of fastening the various pieces may be implemented and a number of fasteners other than two may be used for fastening.

Although the illustrative embodiments herein disclose a “second cover” made with one or two pieces, it should be appreciated that more than two pieces could be used to configure the “second cover” and, similarly, alternative bearing configurations could be implemented to facilitate motion of other portions of the second cover.

While the invention has been described with reference to illustrative embodiments, it will be understood by those skilled in the art that various other changes, omissions and/or additions may be made and substantial equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed for carrying out this invention, but that the invention will include all embodiments falling within the scope of the appended claims. Moreover, unless specifically stated any use of the terms first, second, etc. do not denote any order or importance, but rather the terms first, second, etc. are used to distinguish one element from another.

What is claimed is:

1. A cover system, comprising:
a first cover attachable to a portion of a vehicle;
at least one fastener configured for attaching the first cover to the vehicle portion;
a second cover assembly configured for juxtaposed attachment to at least one of the first cover or the portion of the vehicle, said second cover assembly including a decorative portion that is removably installable in relation to said first cover; and
at least one mechanical fastener configured for installing said second cover assembly in relation to said first cover.

2. The cover system of claim 1 wherein said second cover assembly is comprised of a two piece assembly including a medallion and a background insert.

3. The cover system of claim 2 wherein at least one of said medallion and said background insert is attached to said first cover in a manner that permits at least one of said medallion and said background insert to rotate.

4. The cover system of claim 1 wherein the entirety of said second cover assembly is decorative.

5. The cover system of claim 2 wherein at least one of said medallion and said background insert is comprised of a decorative portion.

6. A Derby cover configured for attachment to a clutch housing of a motorcycle, comprising:
a first cover attachable to said clutch housing;
at least one fastener configured for attaching the first cover to said clutch housing;
a second cover configured for juxtaposed attachment to said first cover, said second cover including a decorative portion that is removably installable in relation to said first cover; and
at least one mechanical fastener configured for installing said second cover in relation to said first cover.

7. The Derby cover of claim 6 wherein said second cover is an assembly comprised of a two pieces including a medallion and a background insert.

8. The Derby cover of claim 7 wherein at least one of said medallion and said background insert is attached to said first cover in a manner that permits at least one of said medallion and said background insert to rotate.

9. The Derby cover of claim 6 wherein the entirety of said second cover is decorative.

10. The Derby cover of claim 7 wherein at least one of said medallion and said background insert is comprised of a decorative portion.

11. A method of assembling a cover system attachable to a portion of a vehicle, comprising:
providing a first cover attachable to said portion of said vehicle; attaching the first cover to the vehicle portion;
attaching a second cover assembly to at least one of the first cover or the portion of the vehicle, said second cover assembly including a decorative portion that is removably installable in relation to said first cover.

12. The method of claim 11 wherein said step of attaching a second cover assembly involves attaching said second cover assembly to said first cover so that at least a portion of said second cover assembly is rotatable with respect to said first cover.
